(19) United States
(12) Patent Application Publication
(10) Pub. No.: US 2003/0129093 A1
(43) Pub. Date: Jul. 10, 2003

(54) Sample processing system for a plasma spectrometer for analysing viscous samples, and samples insoluble at room temperature

(76) Inventors: Olivier Rogerieux, Antony (FR); Pascal Faucher, Fretay (FR); Cendrine Dubuisson, Longjumeau (FR); Yves Danthez, La Norville (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/035,327

(22) Filed: Jan. 4, 2002

(51) Int. Cl. G01N 25/00

(52) U.S. Cl. 422/82.12; 422/82.05; 422/100; 436/171; 436/180; 436/147

(57) ABSTRACT

The invention relates to a sample processing system for a plasma spectrometer for analysing viscous samples, and samples insoluble at room temperature. The system comprises a tray with tubes containing the sample, a heating block comprising a thermoregulation switch and means for collecting the sample from tubes. Said means are connected to a transfer tube transferring the solution that is pumped down by a peristaltic pump. The peristaltic pump is controlled by a controller box and comprises a first pump tubing of internal diameter φ and a second pump tubing of internal diameter φ′. A sample introduction system is fed by the peristaltic pump and contains a nebulizer and a spray chamber placed in a thermoregulated box. According to the invention, said sample processing system is thermoregulated, temperatures are variable and can be selected according to the nature of the sample to analyse.

The invention relates to a sample processing system for a plasma spectrometer for analysing viscous samples. These samples are either insoluble at room temperature or very viscous. They are, for example, polymers, petrochemicals, oil products, resins . . . .

The present invention is advantageously applied to an inductively coupled plasma optical emission spectrometer (ICP-OES). Nevertheless the invention is not limited to such analysers and regards more generally instruments dedicated to analysis.

Plasma emission spectrometry implies an excitation of the material to be analysed sufficient to emit detectable radiations which are characteristic of the elements present in the sample. The emitted radiations are then dispersed and analysed spectroscopically to quantitatively and qualitatively determine elementary compositions of the sample material.

There are two main ways for analysing solid samples. They can be directly introduced into the plasma by laser or spark ablation, and the ablated particles are then entrained with gas flow to the plasma torch, typically Argon. More commonly, they are put in solution either by acid digestion, either by dissolution with an appropriate solvent when the solubility of the solid material allows it. The invention relates to this later mode. The device exciting the elements present in the nebulised solution is an inductively coupled plasma source (ICP). It is a high temperature excitation source (7000-8000 K) which desolvates and vaporises the solution, then atomises, and eventually ionizes the atoms, before exciting them.

Regarding liquid samples, the liquid is introduced into the plasma torch as a spray of droplets. The droplets are vaporised and the elements ultimately atomised/ionised before being excited at levels such as to emit radiations that are spectroscopically analysed.

High viscosity materials represent a special class of materials to be analysed. They require an appropriate solvent such as kerosene so as to improve their pumping rate in the sample processing system. Nevertheless they usually remain difficult to pump unless using a high dilution ratio that results in a low concentration of the sample to be analysed. Moreover, the amount of aerosol at the output of the sample introduction system is very high when nebulising organic solvent. It may cause an excessive plasma solvent loading which would lead to instability, even stop of the discharge. In order to limit the amount of solvent reaching the plasma, an appropriate nebuliser with a low liquid flow rate is then required, especially for hard fat samples. Indeed, temperatures higher than 60° C. are required to solubilise this type of sample, and the amount of aerosol produced is known to increase with the temperature.

Moreover, high viscosity materials are difficult to clean in sample processing system, and sedimentation on the inner walls of the tubes and pipes of the sample processing system can occur for samples insoluble at room temperature. This sedimentation may be important for materials like hard fat samples. The sediment may also change the amount of sample that is pumped by a peristaltic pump, and hence varies the amount of aerosol reaching the plasma torch that has a direct effect on the stability of the measurement with time.

The purpose of the invention is to remedy the shortcomings mentioned above and to propose a system having one or more of the following features and advantages: a simple design, a straightforward use, limited sample preparation and economical for the realisation of a thermally regulated sample processing system for analysing viscous and hard fat samples with a plasma spectrometer. It also provides easy maintenance.

To this end, the invention concerns a sample processing system for a plasma spectrometer for analysing viscous samples and samples insoluble at room temperature, comprising:

a tray with tubes containing the sample,

a heating block comprising a thermoregulation switch,

means for collecting the sample from the tubes, said means being connected to a transfer tube,

the said transfer tube having a length L and a diameter d inside which said sample is pumped down by a peristaltic pump, the said pump being controlled by a controller box and comprising a first pump tubing of internal diameter φ and a second pump tubing of internal diameter φ′,

a sample introduction system fed by to the peristaltic pump and containing a nebulizer and a spray chamber,

According to the invention, said sample processing system is thermoregulated.

According to various embodiments, the present invention also concerns the characteristics below, considered individually or in all their technical possible combinations:

the sample processing system comprises:

heating means for heating the system,

control sensors for measuring the temperature of the system at various locations,

control means for regulating the temperature of the heating means within a predetermined temperature range, and

insulating means to lag the system,

the heating means comprise a heating wire winded around the transfer tube and the top of the means for collecting the sample from the tubes, a heating fan placed underneath the peristaltic pump and a thermoregulated box with a transparent door enclosing the sample introduction system,

the control means comprise thermo-controllers for regulating the heating wire and the thermoregulated box, and a thermosensor positioned on the pump controller box for regulating the heating fan,

the thermoregulated box is a Delrin® box,

the insulating means comprise an insulating ribbed Teflon® tube sheathing the transfer tube and the heating wire, and an insulating box enclosing the peristaltic pump, the heating fan and the thermoregulated box,

the control sensors comprise thermocouples for measuring the temperatures inside the insulating means sheathing the tranfer tube and the thermoregulated box, and a sensor located under the peristaltic pump body for measuring the temperature next to the first and second pump tubings,

the control means for regulating the temperature enable to select the temperature of each constituting part of the sample processing system according to the physical properties of the sample to analyse,

the sample processing system is thermoregulated at temperatures above 50° C. in order to avoid any sediment inside the sample holder, the transfer tube and the tubings of the peristaltic pump,

the means for collecting the sample from the tubes comprise a stainless steel guide for a sample probe and a sample probe holder,

the internal diameter φ′ of the second pump tubing is higher than the internal diameter φ of the first pump tubing,

the material constituting the first and second tubing of the peristaltic pump is both heat and solvent resistant,

To facilitate further description of the invention, the following drawings are provided in which:

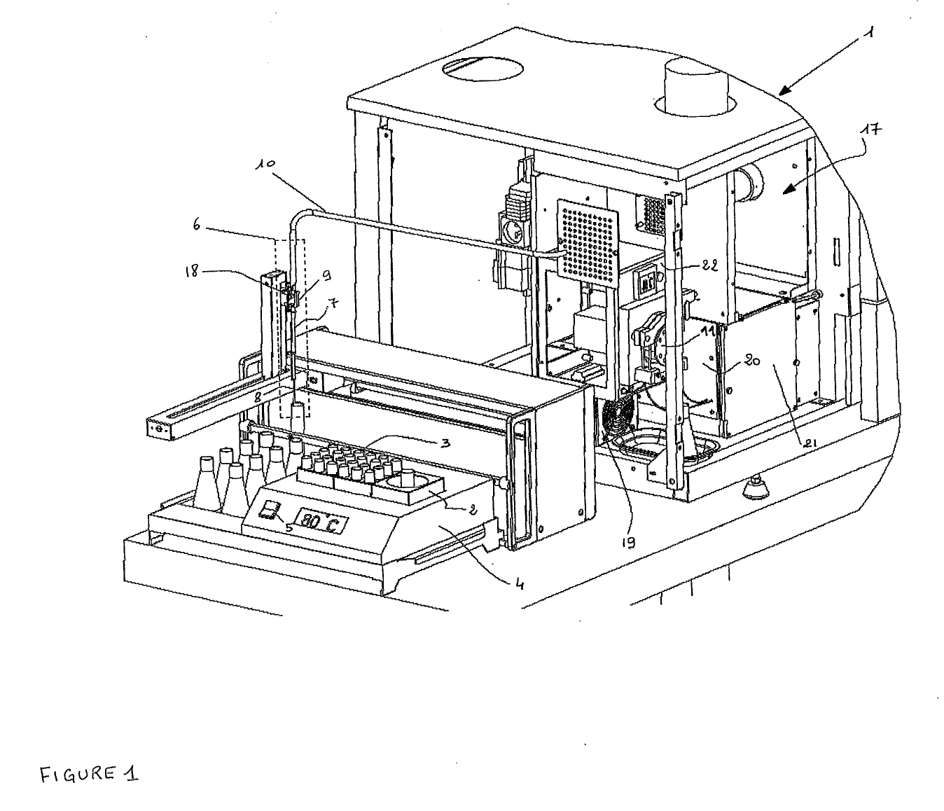

FIG. 1 is a schematic view of a sample processing system thermoregulated according to a particular embodiment of the invention, perspective view;

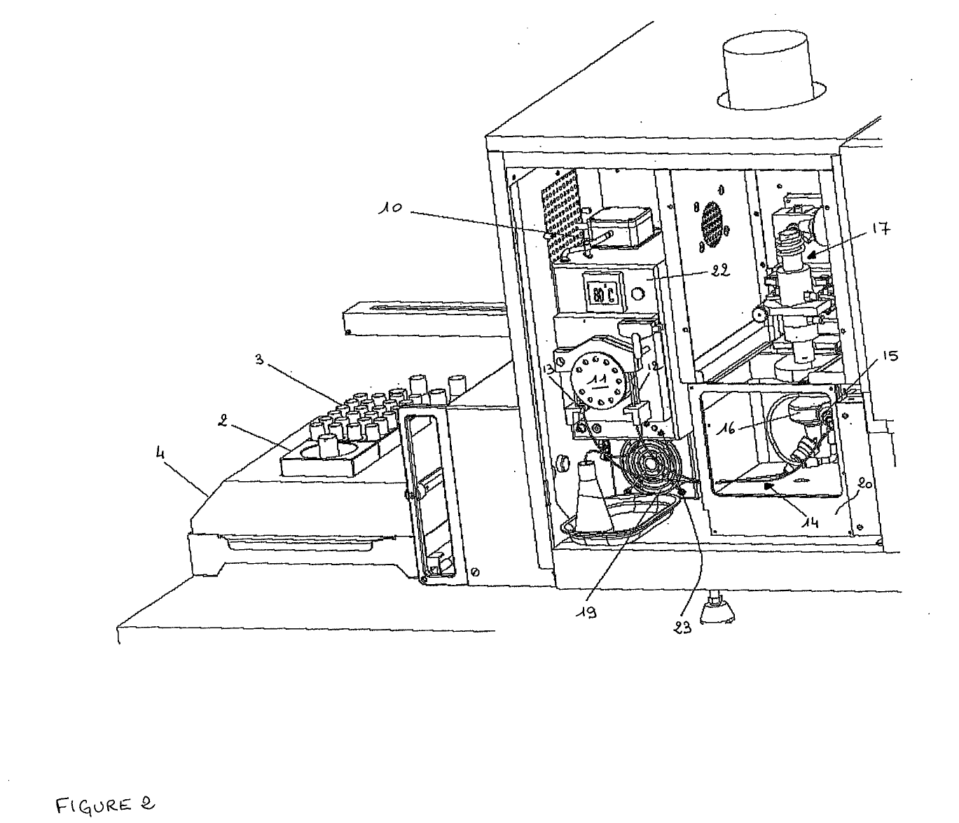

FIG. 2 is a schematic view of an embodiment of the invention in which the plasma spectrometer, side view;

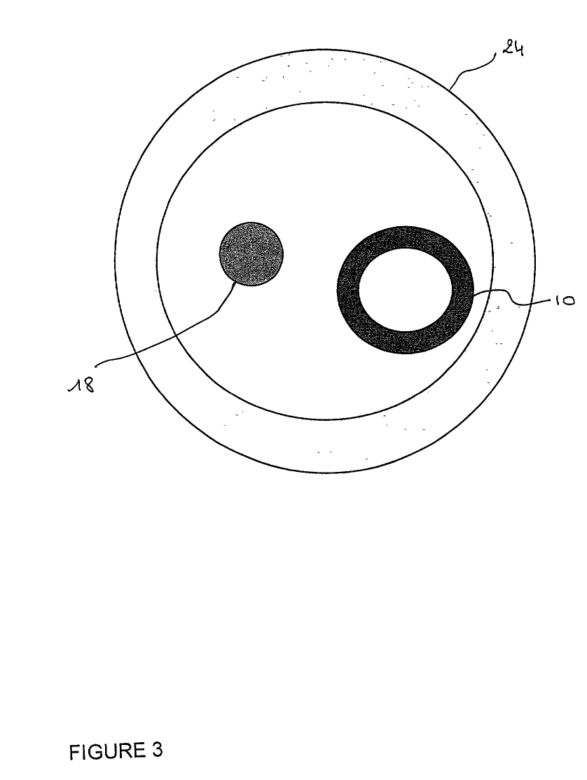

FIG. 3 is a sectional view of the insulating means sheathing the transfer tube and the heating means according to a particular embodiment of the invention;

These drawings are provided for illustrative purposes only and should not be used to unduly limit the scope of the invention.

### DETAILED DESCRIPTION OF THE INVENTION

In order to quantitatively determine elementary compositions of high viscosity materials, they need to be prepared and introduced into the analysing region of a plasma spectrometer via a sample processing system.

A sample processing system 1 comprises a tray 2 with tubes 3 containing the sample, a heating block 4 comprising a thermoregulation switch 5 and means for collecting 6 the sample from tubes 3. These means is usually called “probe”. In a particular embodiment, the tubes 3 are Pyrex® tubes. The material to be analysed is first diluted with an appropriate solvent, then poured into the tubes 3 and heated so as to improve its pumping rate, or keep it soluble, by the means for collecting 6 the sample and avoid sedimentation of unwanted deposit. In a particular embodiment, the tray 2 is placed under suitable ventilation so as to avoid any deflagration and toxicity risk. The temperature of the heating block 4 is adjusted according to the material sample to be analysed. The temperature ranges from 25° C. to 80° C. The means for collecting 6 the sample from the tubes 3 comprise a stainless steel guide 7 for a sample probe 8 and a sample probe holder 9. The said means 6 are connected to a transfer tube 10. The transfer tube 10 has a length L and a diameter d. Said tube 10 is pumped down by a peristaltic pump 11. The pump 11 is controlled by a controller box and comprises a first pump tubing 12 of internal diameter φ and a second pump tubing 13 of internal diameter φ′. The peristaltic pump 11 is driven by a variable speed motor in order to adjust the pumping rate to the type of high viscosity material to be analysed. In a first embodiment, the internal diameter φ of the first pump tubing 12 is comprised between 0.4 mm and 0.6 mm and the internal diameter φ′ of the second pump tubing 13 is comprised between 0.65 mm and 0.80 mm. This embodiment is advantageously adapted for analysing hard fat samples diluted in organic solvent since a low liquid flow is required when increasing the temperature due to the higher efficiency of the sample introduction system. In a second embodiment, φ is between 0.65 mm and 0.80 mm and φ′ is between 0.9 mm and 1.1 mm. This embodiment is advantageously adapted for analysing viscous oils. In a preferred embodiment, the internal diameter φ′ of the second pump tubing 13 is higher than the internal diameter φ of the first pump tubing 12. A sample introduction system 14 is connected to the peristaltic pump 11. It contains a nebulizer 15 and a spray chamber 16.

When a sample is to be analysed, the peristaltic pump 11 is switched on and the sample probe 8 is inserted into the tubes 3 containing the fat material diluted with an appropriate amount of solvent. The fat material solubilised in the solvent is then pumped and flows through the transfer tube 10 and the peristaltic pump 11 to the sample introduction system 14 before being nebulised into the plasma torch 17. In a preferred embodiment, the solvent is kerosene.

At room temperature, sedimentation of fat samples on the inner walls of the tubes 3 and pipes of the sample processing system 1 may occur. In order to limit the risks of such sedimentation and improve the pumping of viscous samples through the sample processing system, said sample processing system 1, according to the invention, is thermoregulated.

In a preferred embodiment, the sample processing system 1 comprises heating means for heating the system, control sensors for measuring the temperature of the system at various locations, control means for regulating the temperature of the heating means within a predetermined temperature range, and insulating means to lag the system.

With reference to FIGS. 1 and 2 and in a particular embodiment according to the invention, the heating means contain a heating wire 18 winded around the transfer tube 10 and the top of the means for collecting 6 the sample from tubes 3, a heating fan 19 placed underneath the peristaltic pump 11 and a thermoregulated box 20 such as a Delrin® box with a transparent door 21 enclosing the sample introduction system 14. The control means comprise thermocontrollers 22 for regulating the heating wire 18 and the thermoregulated box 20, and a thermosensor positioned on the pump controller box for regulating the heating fan 19. The control sensors to measure the temperature of the sample processing system at various locations comprise thermocouples for measuring the temperature of the transfer tube 10 and the temperature inside the thermoregulated box 20, and a sensor 23 located under the peristaltic pump body 11 for measuring the temperature next to the first 12 and second 13 pump tubings. In a particular embodiment, the thermocouples which are of K type are connected to temperature reading means. The insulating means comprise an insulating ribbed Teflon® tube 24 sheathing the transfer tube 10 and the heating wire 18, and an insulating box enclosing the peristaltic pump 11, the heating fan 19 and the thermoregulated box 20. In a preferred embodiment, the first 12 and second 13 tubing of the peristaltic pump 11 are in a material which is heat and solvent resistant such as Viton®, or special PVC (polyvinyl chloride).

The control means for regulating the temperature of the heating means enable to select the temperature of each constituting part of the sample processing system according to the physical properties of the sample to analyse. Preferably, the sample processing system is thermoregulated so that the temperature is above 50° C. in order to avoid any sediment inside the sample holder, the transfer tube and the tubings of the peristaltic pump. When measuring hard fat samples, the temperatures of the heating block 4 and the heating wire 18 are of the order of 80° C., and the temperatures of the sample introduction system 14 and pump tubings 12-13 are higher than 60° C. When measuring viscous oils samples, the temperatures of the heating block 4, the heating wire 18, the sample introduction system 14 and pump tubings 12-13 are higher than 50° C.

1. Sample processing system for a plasma spectrometer for analysing viscous samples and sample insoluble at room temperature, comprising:
a tray with tubes containing the sample,
a heating block comprising a thermoregulation switch,
means for collecting the sample from tubes, said means being connected to a transfer tube,
the said transfer tube having a length L and a diameter d inside which said sample is pumped down by a peristaltic pump, the said pump being controlled by a controller box and comprising a first pump tubing of internal diameter φ and a second pump tubing of internal diameter φ′,
a sample introduction system fed by to the peristaltic pump and containing a nebulizer and a spray chamber,
wherein
said sample processing system is thermoregulated.

2. Sample processing system according to claim 1, wherein the system comprises:
heating means for heating the system,
control sensors for measuring the temperature of the system at various locations,
control means for regulating the temperature of the heating means within a predetermined temperature range, and
insulating means to lag the system.

3. Sample processing system according to claim 2, wherein the heating means comprise a heating wire winded around the transfer tube and the top of the means for collecting the sample from the tubes, a heating fan placed underneath the peristaltic pump and a thermoregulated box with a transparent door enclosing the sample introduction system.

4. Sample processing system according to claim 3, wherein the control means comprise thermo-controllers for regulating the heating wire and the thermoregulated box, and a thermosensor positioned on the pump controller box for regulating the heating fan.

5. Sample processing system according to claim 4, wherein the thermoregulated box is a Delrin® box.

6. Sample processing system according to claim 3, wherein the insulating means comprise an insulating ribbed Teflon® tube sheathing the transfer tube and the heating wire, and an insulating box enclosing the peristaltic pump, the heating fan and the thermoregulated box.

7. Sample processing system according to claim 3, wherein the control sensors comprise thermocouples for measuring the temperatures inside the insulating means sheathing the transfer tube and the thermoregulated box, and a sensor located under the peristaltic pump body for measuring the temperature next to the first and second pump tubings.

8. Sample processing system according to claim 2, wherein the control means for regulating the temperature enable to select the temperature of each constituting part of the sample processing system according to the physical properties of the sample to analyse.

9. Sample processing system according to claim to 8, wherein the sample processing system is thermoregulated at temperatures above 50° C. in order to avoid any sediment inside the sample holder, the transfer tube and the tubings of the peristaltic pump.

10. Sample processing system according to claim 1, wherein the means for collecting the sample from the tubes comprise a stainless steel guide for a sample probe and a sample probe holder.

11. Sample processing system according to claim 1, wherein the internal diameter φ′ of the second pump tubing is higher than the internal diameter φ of the first pump tubing.

12. Sample processing system according to claim 1, wherein the material constituting the first and second tubing of the peristaltic pump is both heat and solvent resistant.
